(19) United States
(12) Patent Application Publication
(10) Pub. No.: US 2006/0212409 A1
(43) Pub. Date: Sep. 21, 2006

(54) Method for placing advertisements in a broadcast system

(76) Inventors: Ryan Steelberg, Newport Beach, CA (US); Chad Steelberg, Newport Beach, CA (US)

Correspondence Address: Todd A. Norton;REED SMITH LLP, 2500 One Liberty Place, 1650 Market Street, Philadelphia, PA, 19103-7301, US

(21) Appl. No.: 11/185,439

(22) Filed: Jul. 20, 2005

Related U.S. Application Data
(63) Continuation-in-part of application No. 11/125,740, filed on May 10, 2005.
(60) Provisional application No. 60/662,951, filed on Mar. 17, 2005.

(51) Int. Cl. H04N 7/16; G06F 17/00; G06G 7/00

(52) U.S. Cl. 705/400; 725/1

(57) ABSTRACT

A media play traffic system is disclosed. The media play traffic system includes at least one hub at least partially remote from at least two media play points, and a normalizer associated with the hub, wherein said normalizer normalizes data inputs for the at least two media play points, wherein the normalization enables importation of a media play list to, and subsequent media play of the imported media play list from, each of the media play points.

### CROSS-REFERENCE TO RELATED APPLICATIONS

This application claims priority to U.S. patent application Ser. No. 60/571,668, entitled “Broadcast Monitoring System and Method”, filed May 14, 2004, U.S. patent application Ser. No. 60/662,951, entitled “Broadcast Monitoring System and Method”, filed Mar. 17, 2005, and is a continuation in part of U.S. patent application Ser. No. 11/125,740 entitled “Broadcast Monitoring System and Method”, filed May 10, 2005, which applications are hereby incorporated by reference herein as if set forth in the entirety.

### FIELD OF THE INVENTION

The present invention relates to broadcasting, and more particularly to the use of a media play traffic system.

### BACKGROUND OF THE INVENTION

Many broadcasters and advertisers struggle with managing broadcast and advertising campaigns, and try to identify which broadcasting and advertising is effective and, perhaps more importantly, which is not. For example, advertisers may spend thousand of dollars and dedicate countless hours producing advertising campaigns, and subsequently monitoring and managing those campaigns, in an attempt to capture the attention of and maximize the response from a selected or targeted audience. Advertisers try to target advertising to particular groups of consumers by tailoring the advertising campaign media, the frequency of the campaign, the nature of the advertisements, and many other variables. Advertisers may place advertisements in newspapers, magazines, trade journals, direct mailings, yellow pages, radio, and television. Unfortunately, advertisers do not presently have an accurate and timely mechanism for monitoring and tracking the delivery or broadcast of their campaigns, let alone the response to their campaigns. This problem may be exacerbated in broadcast radio, where advertisers may not receive verification of delivery or broadcast of advertising campaigns for up to weeks after the scheduled run of campaigns. An automated system that is capable of providing the advertiser with real-time, tailored and accurate reports on which radio advertising campaigns and programs are and were delivered, and on which station, and when, has thus far eluded those skilled in the art.

Attempts to identify and track where and when select radio advertising campaigns and radio broadcast programming are broadcast over the air have, to date, included using computer automated or manual listening posts deployed in geographic markets to record, log and analyze radio broadcasts over the air to identify songs, advertisements, and selected programming. Advertisers may contract with broadcast monitoring firms to receive reports on what advertising and radio programming was broadcast. Such a mechanism is error-prone, inefficient, and untimely. Marketers and advertisers, who often focus on increasing sales and driving product and service demand, do not have the time to wait for reports to be generated, particularly when, even after waiting for a report, the report may include discrepancies and errors.

Advertisers may be conducting costly advertising campaigns on a very tight schedule, and may need to act on a failed delivery or broadcast, either on a certain station or across a certain market, by finding alternative advertising opportunities. Such a method might come to be if the advertiser could verify immediately whether the campaign had been delivered. Monthly affidavits or reports are often inadequate to service the needs of advertisers. Reporting often does not capture crucial information to the advertiser, at least in that such reports generally fail to report the aggregate audience size, segmented by demographics and geography, at the time of advertising delivery. Such information is usually not available through any existing radio advertising and programming auditing or reporting services. However, such information may be valuable and crucial to an advertiser. An advertiser may prefer to identify the audience and those potential consumers who listened to the advertising, and directly compare those metrics against response and sales numbers.

An effective mechanism for an advertiser to monitor and track radio advertising delivery has, to date, eluded those skilled in the art. Accordingly, a need exists for a system and method for providing the broadcaster/advertiser with real-time, tailored and accurate reports on which broadcast and advertising campaigns and programs were delivered, including station information, such that the broadcaster/advertiser may identify the audience and those potential consumers who listened to the broadcast or advertising, and may directly compare those metrics against response and sales numbers.

Additionally, radio stations often operate with daily unsold advertising inventory, such as public service advertisements, bonus advertisements, unsold and/or remnant advertisements and preemptible advertisements, for example, resulting from market demand factors, poor ratings, station inefficiencies, trafficking logistics, programming logistics, and 3^{rd} party variables. This daily unsold advertising inventory may account, on average, for up to 30% of the advertising on a daily basis.

Specifically, a local station may load advertising orders into the traffic system and when these advertisements are scheduled against the schedule log gaps and holes may result. This may be caused by not having an advertisement to schedule during a certain time slot. Generally systems fill these gaps with public service advertisements, bonus advertisements and/or low-priority advertisements in order to fill in the schedule.

Further, the typical radio station and radio network use a booking process that includes manual human processes that preclude radio stations and radio networks from focusing on or accepting small focused radio ads. Further, the creative or commercial production costs can range in the thousands of dollars to produce and create quality 30 second and 60 second commercial audio spots for radio. And, in addition, the time necessary to create the creative can take up to several weeks. The management of the creative may be limited and may have a slow turnaround time thereby causing delayed decision making. And further, there is minimal to no reporting on campaign scheduling, broadcast, delivery or airplay checks.

Generally, ads go live within several days to a few weeks after booking with costs in the neighborhood of $1,000 to $5,000 minimum. The creation of commercial spots costs several thousand dollars and there is no way to schedule ad delivery evenly over a set period of time. Multi-station campaign targeting by market or format takes weeks to plan and successfully launch.

Therefore a faster and cheaper way of managing ads, which promotes a way to schedule delivery over a period of time across multi-stations by market, format, demographics or events, is needed in a substantially automated fashion.

### BRIEF DESCRIPTION OF THE FIGURES

Understanding of the present invention will be facilitated by consideration of the following detailed description of the present invention taken in conjunction with the accompanying drawings, in which like numerals refer to like parts, and wherein:

FIG. 1 illustrates an architecture of a communication system 100 according to an aspect of the present invention;

FIG. 2 further illustrates the system of FIG. 1; and,

FIG. 3 illustrates a schematic diagram of the flow of information within the communication system of FIGS. 1 and 2;

FIG. 4 illustrates an account management environment of the present invention;

FIG. 5 illustrates an account management environment of the present invention;

FIG. 6 illustrates an account management environment of the present invention;

FIG. 7 illustrates an account management environment of the present invention;

FIG. 8 illustrates an account management environment of the present invention; and

FIG. 9 illustrates an account management environment of the present invention;

FIG. 10 illustrates an account management environment of the present invention;

FIG. 11 illustrates an account management environment of the present invention;

FIG. 12 illustrates an account management environment of the present invention;

FIG. 13 illustrates an account management environment of the present invention; and

FIG. 14 illustrates an account management environment of the present invention;

FIG. 15 illustrates an account management environment of the present invention;

FIG. 16 illustrates an account management environment of the present invention;

FIG. 17 illustrates an account management environment of the present invention;

FIG. 18 illustrates an account management environment of the present invention; and

FIG. 19 illustrates an account management environment of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical communication system and method of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention enables the monetizing of unsold inventory. Specifically, the present invention utilizes a schedule file to identify unsold inventory, unsold avails, and files these slots with paid advertisements.

The present invention provides a system and method for accurately and timely identifying where and when a radio advertisement or radio program is broadcast. The present invention may provide a communication environment configured to monitor, track, and report on radio verification of broadcast information related to a specific advertisement or program. This broadcast information may be transmitted via a network-accessible server and formatted for retrieval over a network. The present invention may be designed to permit a reporting-service subscriber to connect, such as via a network, to a server and request a report, which may be based on the verification of broadcast information, for a selected advertising campaign or radio program.

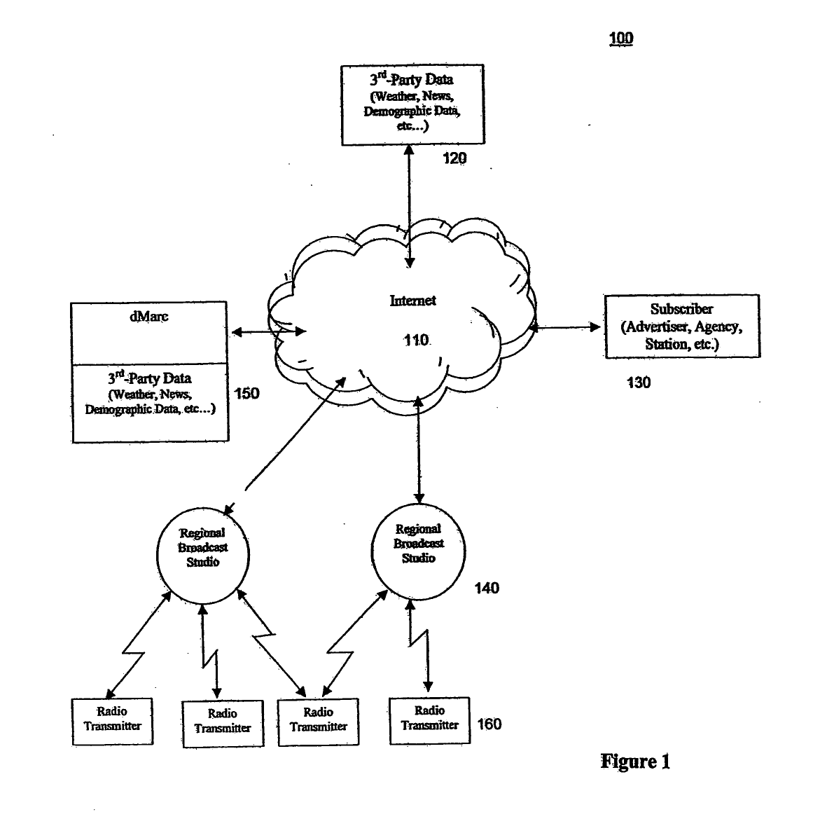

Referring now to FIG. 1, there is shown an architecture of a communication system 100 according to an aspect of the present invention. System 100 may include a networked environment 110 communicatively coupling party data 120, subscriber 130, at least one regional broadcast studio 140, and a broadcasting hub 150. At least one regional studio 140 may be further communicatively coupled to at least one radio transmitter 160.

Communication system 100 may include a broadcasting hub 150 configured to store and forward verification of broadcast information of radio advertising and radio programming from at least one regional broadcast studio 140. This verified information may be forwarded to a data recorder for recordation of a sample of the information. Further, the recorded verified information may be parsed into campaign information and remainder of the broadcast information, wherein the campaign information may include radio advertising or radio programming information associated with a broadcast event. The data recorder may make accessible the verified information to networked environment 110 such that a myriad of verified information may be accumulated as necessary. Networked environment may forward the verified information to a subscriber 130 and/or broadcasting hub 150 responsive to a request for the verified information.

According to an aspect of the present invention, the identification of when a radio advertisement or radio program was broadcast may be achieved. This identification may be performed within the broadcasting hub 150. Within hub 150 a data collector may identify verification of broadcast information related to an audio file associated with an advertising campaign or radio program, and may forward that information to networked environment 110. Hub 150 may include software for tabulating and formatting the information into a serviceable report, such as in response to a request by subscriber 130. The information in, for example, such a report, may be presented based on many different criteria, such as, for example, the total number of advertising or programming broadcasts per campaign, a listing of which stations the radio advertisement or program was broadcast over, an hourly breakdown of the broadcasts, the demographics of the broadcast audience, the geography of the broadcast audience, and/or the format of the radio stations, for example.

According to an aspect of the present invention, the reports available to subscriber 130 may reflect the latest information available. The verification of broadcast information may be forwarded from the data collector to networked environment 110, such as when the verification of broadcast information becomes available from broadcast hub 150. Such a substantially real-time report may provide subscriber 130 with substantially real-time data regarding the delivery of radio advertisements and radio programs.

According to an aspect of the present invention, the verification of broadcast information associated with advertising campaigns or programs may be combined with other information, and may be stored in additional databases either resident on or accessible by networked environment 110, to produce reports of demographic information about the audience of the advertising campaign or program. Such other information for combination with the verification information may be obtained, for example, from relevant internet or intranet sites, either automatically in response to an instruction included with the submission of the program to be broadcast, or manually upon receipt of a subscriber request.

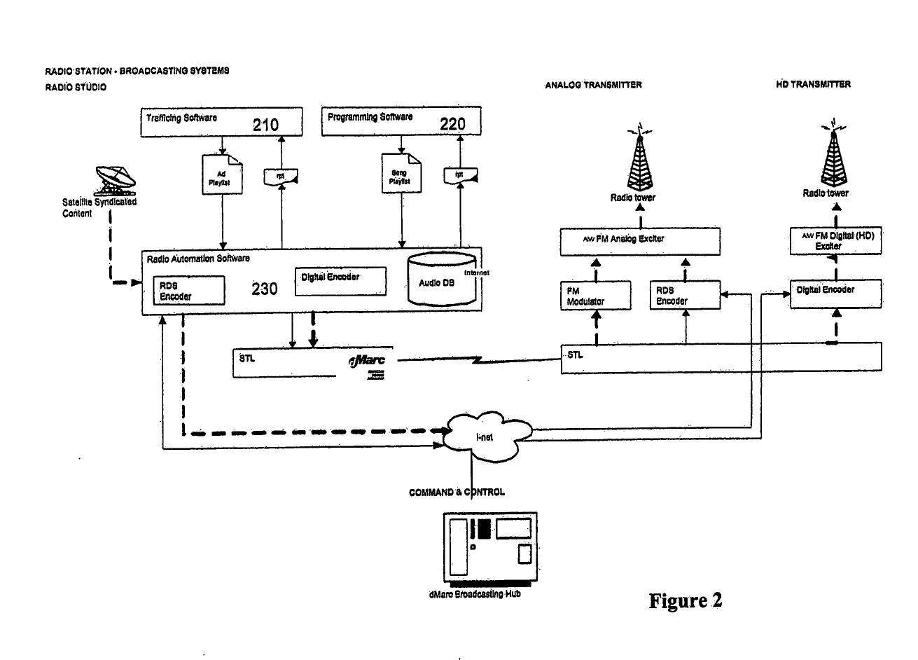

In order to more fully describe the interconnectivity, an exemplary embodiment is set forth herein below. Referring now also to FIG. 2, there is shown a system according to an aspect of the present invention. Subscriber 130 may conduct one or more broadcast or advertising campaigns by purchasing radio advertisements across several local and regional radio stations. Subscriber 130 may distribute audio commercials to the radio stations for scheduling by a regional broadcast studio 140. Subscriber 130 may verify the delivery and track the broadcast of each of the one or more advertising campaigns and associated audio commercials. It may be beneficial for subscriber 130 to engineer the one or more advertising campaigns with a unique and corresponding file name. In this regard, each audio commercial digital file may have a subscriber 130—associated, unique file name. The audio commercial digital files associated with the advertising campaigns are referred to in this discussion as “campaign creatives.”

Regional broadcast studio 140 may broadcast a campaign creative for subscriber 130. Regional broadcast studio 140 may initiate a broadcast of the campaign creative by scheduling broadcast delivery within its trafficking system 210 or programming system 220. The campaign creative may be loaded onto radio automation software 230 of station 140. Radio automation software 230 may include the scheduling and/or “flight” information as provided by trafficking system 210 and programming system 220. Broadcast hub 150 may forward scheduling information regarding the campaign creative, captured from radio automation software 230, to data collector. At the scheduled time, radio automation software 230 may stream the campaign creative to a station transmitter 160 for subsequent broadcast over the air. Broadcast hub 150 may forward verification of broadcast information regarding the campaign creative, captured from radio automation software 230, to data collector. The data collector may accumulate and/or store the information passed from broadcast hub 150.

According to an aspect of the present invention, data collector may isolate the verification of broadcast information related to campaign identifiers, for example, by including a table identifying the campaign identifiers. When verification of broadcast information arrives regarding one of the campaign identifiers in the campaign identifier table, the data collector may forward that verification of broadcast information (“campaign information”) to hub 150. The data collector may forward the campaign information as it arrives, or on a timed basis, such as in fifteen minute increments, one-hour increments, several-hour increments, or other increment known to those skilled in the pertinent arts. The rate at which the campaign information is passed from the data collector to hub 150 may limit how current, or real-time, a report may be. In this regard, the data collector according to an aspect of the present invention may be configured to provide the campaign information to hub 150 in real-time, such as not later than a few hours after the campaign information becomes available at the data collector. A portion of hub 150 may include a web server that receives the verification of broadcast information associated with each campaign identifier (the campaign information) from the data collector and stores that information on a permanent storage medium, such as a hard disk drive. The web server may tabulate the campaign information based on each campaign identifier. The table containing the campaign information may be as current as the rate at which the data collector provides the campaign information to the web server. Consequently, hub 150 via the web server may be able to generate reports of the broadcast of radio advertisements and radio programming in substantially real-time.

Hub 150 may provide access to the tabulated data over internet 110. Although internet 110 may be described as a wide area network for making the reports available to subscribers, those skilled in the art will appreciate that the system and method of the present invention encompasses any wide area network that allows access by subscribers to data stored on hub 150. Subscriber 130 may access hub 150 via a connection to internet 110. The connection to internet 110 may be any conventional connection that allows access to hub 150. For example, subscriber 130 may access hub 150 using TCP/IP and a conventional dial-up connection over a modem, or a dedicated connection that provides constant access. Hub 150 may have a unique HyperText Transfer Protocol (HTTP) address, a unique FTP address, or any other addressing scheme that allows subscriber 130 to identify hub 150.

Hub 150 may include server software, such as within a web server, that may allow subscriber 130 to request a report of a particular radio advertisement broadcast or radio program broadcast at any time. For example, subscriber 130 may connect to internet 110 in the middle of the day on a Tuesday. At that time, subscriber 130 may log on to hub 150 using a secure access protocol and issue a request to the web server to provide a report. The issued request identifies the particular radio advertisement or radio program of interest by campaign identifier. Hub 150 may respond to the request by reading the data stored in the table of campaign information associated with the campaign identifier provided by subscriber 130. Software resident on the web server may tabulate the report in accordance with the request. Finally, the web server publishes, such as in HTML or XML format, for example, the report to subscriber 130. In this manner, subscriber 130 may access and query the web server as frequently as desired to determine the broadcast of a particular advertising campaign or radio program.

Hub 150 and the web server may be configured to transmit reports to subscriber 130 at predetermined intervals, such as immediately, hourly, daily, weekly, or other time frame. For instance, software may be configured to simulate a subscriber request and cause the web server to generate and transmit the report to subscriber 130. Alternative means of delivery may also be employed, such as via electronic mail. These and other alternatives will become apparent to those skilled in the art upon a study of the disclosed embodiments.

Hub 150 and the web server may be configured to generate the report in response to a triggering event. Examples of such a triggering event may be a confirmation of broadcast for a select advertisement or program, or of a situation wherein an advertisement or program was scheduled to broadcast, but failed to deliver, or of an advertising campaign reaching a dollar cap value, for example. For instance, the web server may be configured to analyze the campaign information as it is received from the data collector. If the campaign information reflects that an advertisement with a specified campaign identifier was scheduled to broadcast at a certain time, but failed to broadcast, the web server may respond by issuing a flag to subscriber 130. According to an aspect of the present invention , the web server may be configured to extract from the campaign information the advertising client's telephone number, email, fax, or the like associated with the campaign identifier and transmit the broadcast information directly to subscriber 130 or someone associated with the subscriber, such as to follow up on the failed broadcast. The campaign information may be transmitted by digital or voice pager, by e-mail message, by human interaction, or by any other mechanism for alerting subscriber 130. In that manner, subscriber 130 may be substantially immediately notified that an advertisement failed to broadcast, and be provided with the radio station's contact information and advertising client information. Those skilled in the art will see the enormous benefits created by this aspect of the invention over existing technologies.

As may be evident to those possessing an ordinary skill in the pertinent arts, a myriad of reports may be created. By way of non-limiting example only, such reports may include campaign delivery by station, campaign delivery by market, campaign delivery by date, campaign delivery by hour, broadcast failure, and demographic reports. A campaign delivery by station report may identify upon which station a selected radio advertisement or radio program was broadcast. This report may enable subscriber 130 to verify delivery across a certain station, or within an associated geographic region. A campaign delivery by market report may identify the geographic market across which the campaign was broadcast. This report may enable subscriber 130 to verify delivery and coverage within a certain market. A campaign delivery by date report may provide subscriber 130 with per-day totals of broadcasts associated with a specified campaign. Subscriber 130 may use this type of report to easily identify those days with the heaviest advertising and programming response, such as for support planning purposes. A campaign delivery by hour report may provide subscriber 130 with per-hour totals of broadcasts associated with a specified campaign. Subscriber 130 may use this type of report to identify those day parts with the heaviest advertising and programming response for support planning purposes. A broadcast failure report may provide subscriber 130 with a listing of the campaigns that were scheduled but failed to broadcast. This information allows subscriber 130 to attempt to manage sales support, and take action to remedy failure. A demographic report may be provided. For example, the advertising campaign, broadcast across a specific market, may be mapped to area code or zip code to provide subscriber 130 with a broad overview of geographic locations of the receiving broadcast audience. Additional databases, such as those available from Census information, may be employed to generate financial, ethnic, and age-related demographic information which may be of use to subscriber 130.

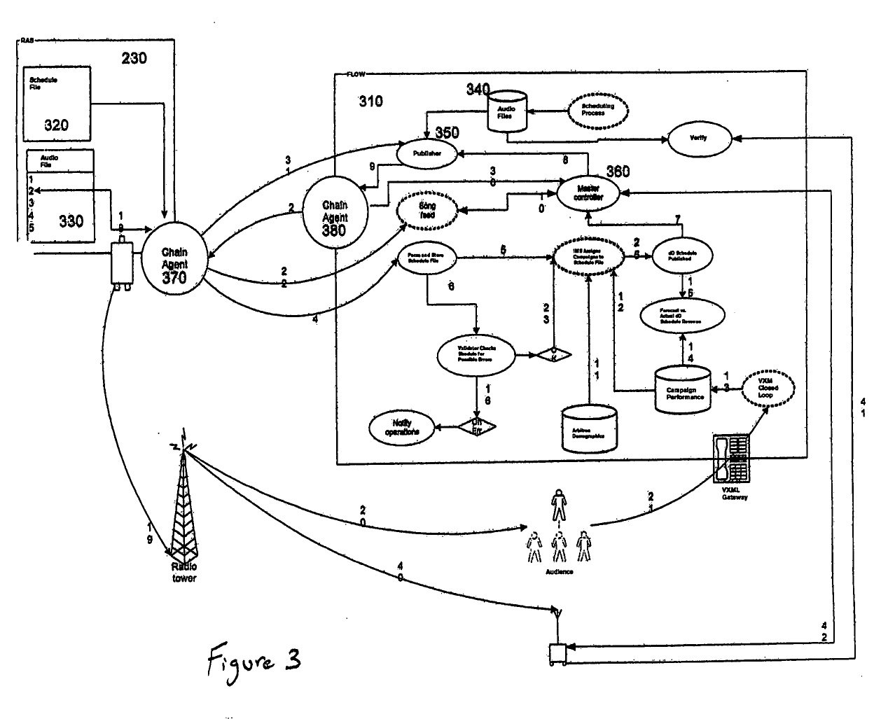

Referring now to FIG. 3, there is shown a schematic diagram of the flow of information within the communication system of FIGS. 1 and 2. FIG. 3 shows information flow 300. Information flow 300 includes two principle regions, RAS 230 and flow 310. RAS 230 may include schedule file 320 and audio file 330. Flow 310 may include audio advertisement files 340, publisher 350, and master controller 360. The flow of information will be described with reference to the numerals labeling the arrows representing the flow of information.

RAS 230 may include a flow of information for a new schedule file 1. New schedule file may originate with schedule file 320 and be transmitted to a first chain agent 370. This transmission may occur by an external software that publishes a new schedule file to the RAS 230 file system. A first chain agent 370, via a directory watcher process, detects new schedule file 320, and reads it off of disk. This new schedule file 320 may originate or be taken from several systems within the radio station and or from a location outside the studio itself (in the case of remote network programming). Eventually, schedule file 320 may be created while remaining unpublished to RAD 230. The filling algorithm may be local, and the rules for filing the inventory may not be dynamic nor take into consideration a revenue maximization function. For example, 3rd party groups today will “buy” unsold inventory in advance and give the station 1-N ads, that the station can “fill” unsold inventory. The station in this case is selling unsolds in advance without a guaranteed schedule.

First chain agent 370 residing in RAS 230 may pass information to a flow 310. This retrieval of a new schedule file 320 may be seen in FIG. 3 as link 4. This information may be passed to a parse and store step located within flow 310. As the RAS chain agent 370 reads schedule file 320, the file may be transmitted to flow 310. The dD preemptable ad avails (dD Avails) may be parsed from schedule file 320 and stored for further processing. The original schedule file 320 may be stored for billing, accounting, and auditing purposes. This parsing and storing, shown and described to occur within flow 310, may be achieved at studio 140.

After parsing and storing the schedule file, the information is transmitted to the IMS where the campaign is assigned to schedule file 320. This transmission is shown by label 5 and may occur within flow 310. This represents the delivery of the dD Avails to IMS. Rather than collecting the unsold inventory report in a central location, the central location, which tracks ad effectiveness, may publish results to each station and the local station software may use this information to make “intelligent” insertion over unsold inventory. The available ads may need to be published or delivered to station 140 and station 140 may need to receive performance data on those campaigns, so that the local engine may make decisions.

Similarly, after parsing and storing the schedule file, a validator checks for possible scheduling errors. The transmission of information to the validator is shown by label 6. The validator may input this information and analyze schedule file 320 for errors in tag structure, frequency of tags, station contractual obligations, such as minimum number of spots per period, and other errors known to those possessing an ordinary skill in the pertinent arts. This validation, while shown to occur within flow 310, may occur local to hub 150. The validator may output information to IMS on whether the schedule file 320 is validated. This validity feedback is shown by label 23. Once IMS receives an appropriate response from the validator, IMS may process the new dD Avails, by assigning dD advertisements and specific creatives to specific dB Avails. This IMS, while shown to occur within flow 310, may occur local to hub 150.

After the IMS assigns campaigns to the schedule file, the processing may be complete, and the information in the schedule transmitted to a publisher as shown by label 25. The result of the processing of dB avails is a dB Schedule, which is specific to each station. This creation, while shown to occur within flow 310, may occur local to hub 150.

After publishing the schedule, information may be transmitted to the master controller as shown by label 7. The master controller may operate as the brains behind “trafficking” the unsold spots slated for preemption within the dB schedule file. The master controller receives the song feed, including ads, as to what is being played currently on a station. The master controller uses this feed to determine where in the current schedule file a station is. The master controller manages the replacement of the ads, and the swapping back of the original ad, once the spot has run. The master controller, while shown to occur within flow 310, may occur local to hub 150.

A feedback system may be created for creating new schedules as shown by labels 8, 9, and 2. This transmission path may transfer information from the master controller to the publisher, label 8, from the publisher to the second chain agent 380, label 9, and from the second chain agent 380 to the first chain agent 370. Thus, there is a schedule for a given station, master controller instruction to pre-empt a spot, and master controller instructions to restore the preempted spot after it has played. The master controller interrogates the dB Schedule file for a given station, identifying the names of all of the creatives that are scheduled to run, and publishes these creatives to the station via the 8-9-2 pathway. The chain agent examines a cache of previously stored ads to determine that it has stored all creatives. The master controller, if it determines that a spot is ready to be pre-empted, may send a notification via the 8-9-2 pathway, to instruct the chain agent to swap creative one for creative two. The chain agent may confirm receipt of this message via the 2-30 pathway.

The chain agent may manage the physical preemption process. Instructions to preempt an ad may be delivered via path 18 to audio files 330. The chain agent may preserve the original audio file X by either renaming it or moving it to a different directory on the file system. The original file, the dD spot and the slated pre-emption may be copied into a directory of the same file name. The header information within the file, used to populate the RAS screen, may be different and reflects the actual ad that will run even though the file name is the same. The header information may identify what is written to the RAS log files for billing purposes and the station may be aware that the preemption occurred. Once this preemption has been completed or failed due to some error, status may be published via pathway (2-30). The chain agent, which may be responsible for sending the song feed, known as the log, of what is actually playing on the station, such as by pathway labeled 22, may monitor the feed to see the pre-empted spot run. Once it has run, the chain agent may swap the original ad back and notifies the master controller.

The feedback pathway labeled 2, 31 may enable the chain agent to determine if the audio file is available. The chain agent may request the publisher, via pathway 30, to send it a specific creative. The publisher responds by sending the file along with a checksum to confirm the file was not corrupted in transmission via pathway 9, 2.

The chain agent 370 may also prompt the song feed across pathway 22. The chain agent, depending on the RAS configuration, may either watch the log file on the RAS to determine what is being played over the air, or may receive a data feed from the RAS directly containing play history. The chain agent may scrub the feed and publish it to FLOW. The song feed may be exported directly over the WAN to FLOW and a local agent may not be required.

In the event that the validator determines there to be an error, information may be transmitted across pathway 16 in order for notification of an error to occur. If errors are found in the schedule file, such as a result of a contractual breach or a technical issue, a set of rules may be setup dependent upon the type or error and the station the error occurred on, to notify both systems and people that are tasked to resolve the errors.

The event ad may be played. As shown in pathways 19, 20, 21 the information derived hereinabove may be transmitted to the gateway. The information may be transmitted to a radio tower across pathway 19. Radio tower broadcasts to an audience across channel 20. As the audience responds to the pre-empted ad, by calling a telephone number, FLOW traps the caller ID or is notified from the call center, in substantially real time, or on a daily basis, for example.

New calls may be logged, and the information may be provided to IMS across paths 13, 12. As calls are logged, the calls may be tracked against the dB schedule file. Revenues and performance metrics may be tracked given audience size, Arbitron data, and other factors. This information may be used by IMS to optimize ad targeting.

Campaign performance, in addition to being transmitted to IMS, may be transmitted across pathway 14 to a forecaster. Forecaster may compare actual performance with predicted performance and revenues. The IMS algorithms may be evaluated based upon the accuracy of the predications. Over time, the forecaster may project future revenues based on inventory flow and ad campaigns scheduled in the system. The forecaster may provide automated notification to station traffic managers that the present invention may result in income.

A verification may occur. The pathway labeled 40, 42 may demonstrate the availability of verification. The master. control, in addition, may instruct the local chain agent at the station to pre-empt a spot and, responsive to the notification, may notify a digital radio that can receive the broadcast of the station to record the ad scheduled by the master controller, such as by sending a schedule or a real time notification to start/stop recording. The audio may be streamed over the WAN and recorded within the FLOW environment. Verification may occur across transmission path 41 demonstrating an ad spot recorded off the air. Once the file is recorded, it may be transmitted to FLOW to verify. The verify process may compare the audio file recorded to the audio file that was shipped to the station. If there is a match, then the ad spot may be logged as verified. If no match exists, the file may be routed to a human capable of listening to the original and the recorded file to determine if the spot matches. If no match still exists, further action may be taken. Subscriber 130 may option to listen to the recorded spots and the original in one of several verification reports. This audio may be streamed over the WAN and recorded within the FLOW environment.

The present invention provides the ability to create and broadcast engaging radio commercials across a myriad of radio stations in a efficient time period, such as less than 24 hours, for example. The present invention allows an ad creator to choose the markets, select the format, specify the time of day and set the price. Campaigns may be created so that creators may target ads by market or region, specifying the time and dates and selecting the desired formats. The present invention provides creators with visibility and control over every aspect of the campaign. The present invention may be used to directly create broadcasts and track national and local advertising campaigns in substantially real time across any network of radio stations. The present invention allows for advertising on radio in a cost effective and efficient manner while creating professional produced audio commercials, targeting radio ads to specific markets, formats and time blocks, specifying weekly ad budgets and setting maximum rate spot and accessing real time broadcast and audience reports on-line in a 24/7 fashion.

The present invention provides for access and control. Such access and control may allow access to this type of service by those who may not have had such access previously. Many large businesses are currently able to provide radio advertisements and large campaigns across a country or across a region. The present invention may provide access to ad campaigns to those businesses that previously were without such access and may provide large business with access in another avenue, such as with lower cost. Such access and control, and inexpensive cost, may provide campaigns to those who were not available to previously. In addition, the present invention minimizes the logistic issues of placing and managing radio campaigns. In so doing and in using the present invention, a creator may set the price, target campaigns, distribute, broadcast and track radio campaigns. A creator may set weekly ad budgets with guaranteed placement. Ads may be targeted nationally, regionally or by format and may access a radio advertising network which may include many popular U.S. radio stations spanning the majority of the cities in the United States, including 1,800 of the most popular radio stations.

The present invention may dynamically optimize a campaign to reach the targeted audience while minimizing the price. The present invention may identify, target and deliver radio commercials by radio format, for example Rock, Top 40, R&B, News or Talk, Sports or any other format known to those possessing an ordinary skill in the pertinent art. The system of the present invention may also deliver ads based on the time of day or day of week or the demographics of a station or audience, for example adult 18-49, male/female, or any other demographic known to those possessing an ordinary skill in the pertinent arts. Independent variables may also be optimized, including the local weather at a station or series of stations, traffic conditions and other variables known to those possessing an ordinary skill in the pertinent arts. In addition, copies of suggestions for commercials for each of the campaigns may be provided.

The present invention enables direct, on-line creation targeting and broadcast of radio campaigns and such ads may be live on the radio in less than 24 hours. Further, the invention has a creative generator that enables advertisers to create produced spots within 48 to 72 hours for use in the campaigns. Additionally, the present invention supports multiple ad creatives and reporting enables tracking of individual creative ad performance and changing of creatives in real time.

The present invention has ads go live in 24 to 72 hours depending on how much creative production is involved. The present invention has a user-friendly on-line interface to enable an ad buyer to select markets, formats, dates and times in less than 5 minutes. The present invention may be used to fulfill many goals. For example, you can expand into small to mid-sized markets cost effectively, you can drive consumers to call toll free numbers to tryout new services, and you could start advertising on radio with a limited budget of less than $250 a month, for example.

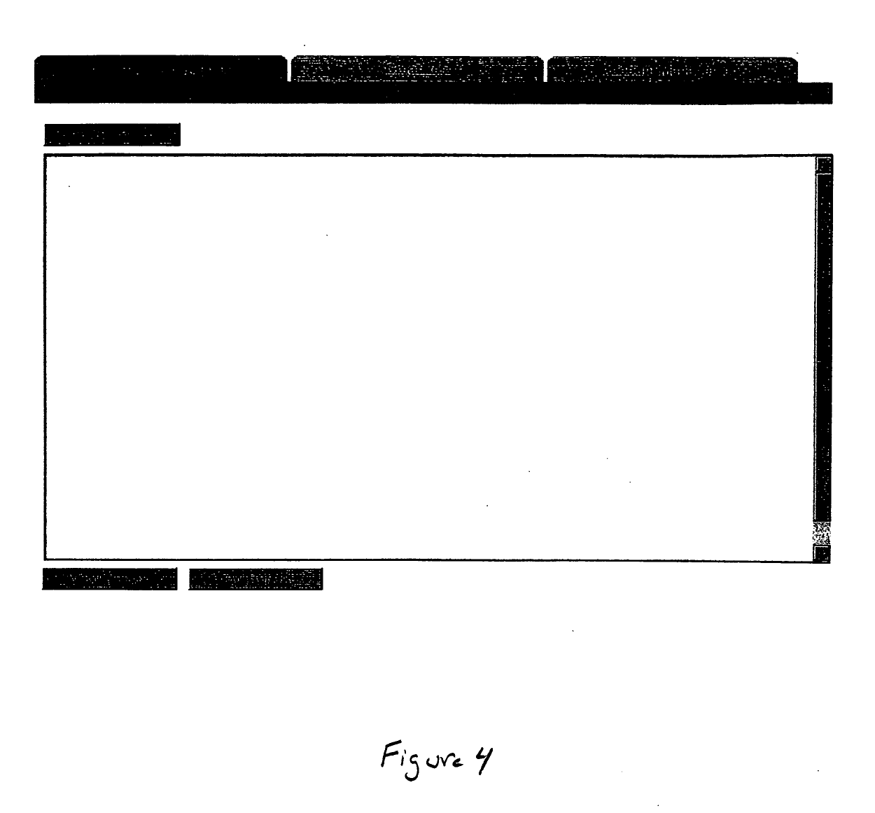

According to an aspect of the present invention, the system of the present invention may be divided into three categories: Campaign Management, Creatives and Account Management. Campaign management is used to manage when, where, and how ads in the campaign are broadcast. Creative is the sub-section where new ads may be created to be used in a campaign. Account management is the section where account information may be reviewed. As may be seen in FIG. 4, a three panel window may be used to control which sub-section is being activated.

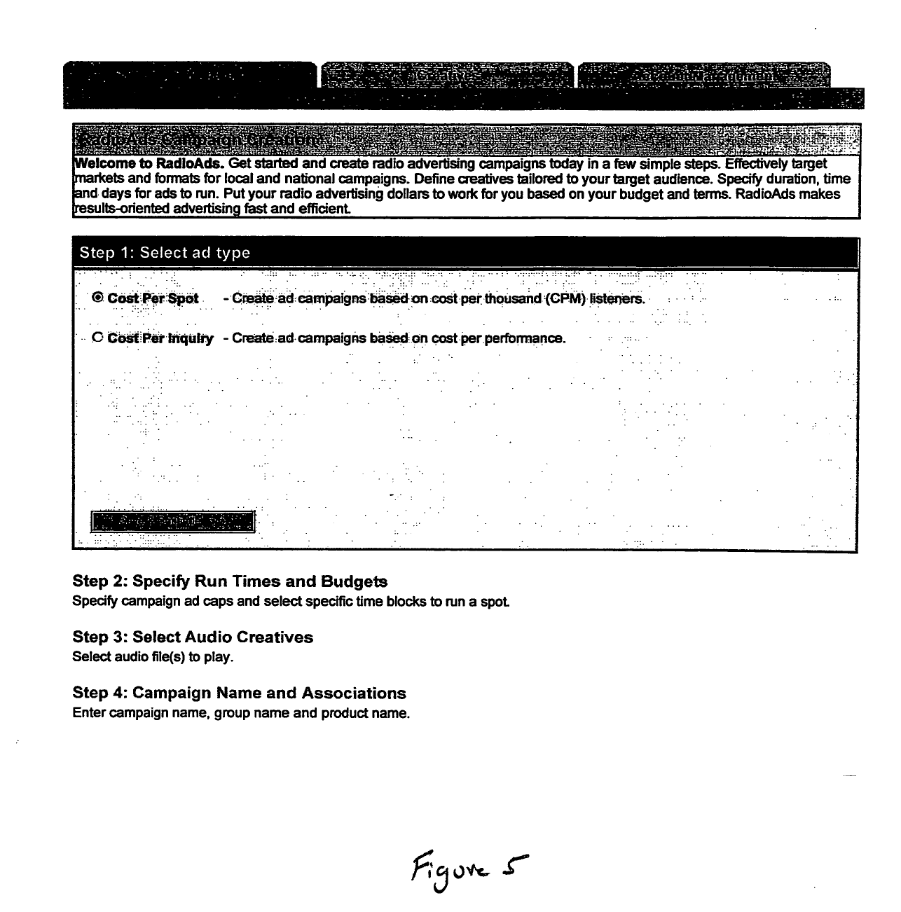

Upon selecting the campaign management tab of FIG. 4, and creating a new ad the window of FIG. 5 may be activated. Within the Campaign Management section a user would have an opportunity to create a new ad. In creating a new ad, a new campaign creation may be created and the user may be walked through a campaign creation. First and foremost, the ad type must be selected. Options of ad types include cost per spot and cost per increase, for example. A cost per spot is an ad campaign based on cost per thousand listeners or any other denomination of listeners as may be realized by those having a ordinary skill in the pertinent art or a cost per inquiry where as an ad campaign based on cost per performance. A cost per inquiry is an ad campaign where the cost is based on performance. One of the two types may be selected on the display of FIG. 5. Once the ad type is selected, the user may select ‘Save’ and ‘Continue’.

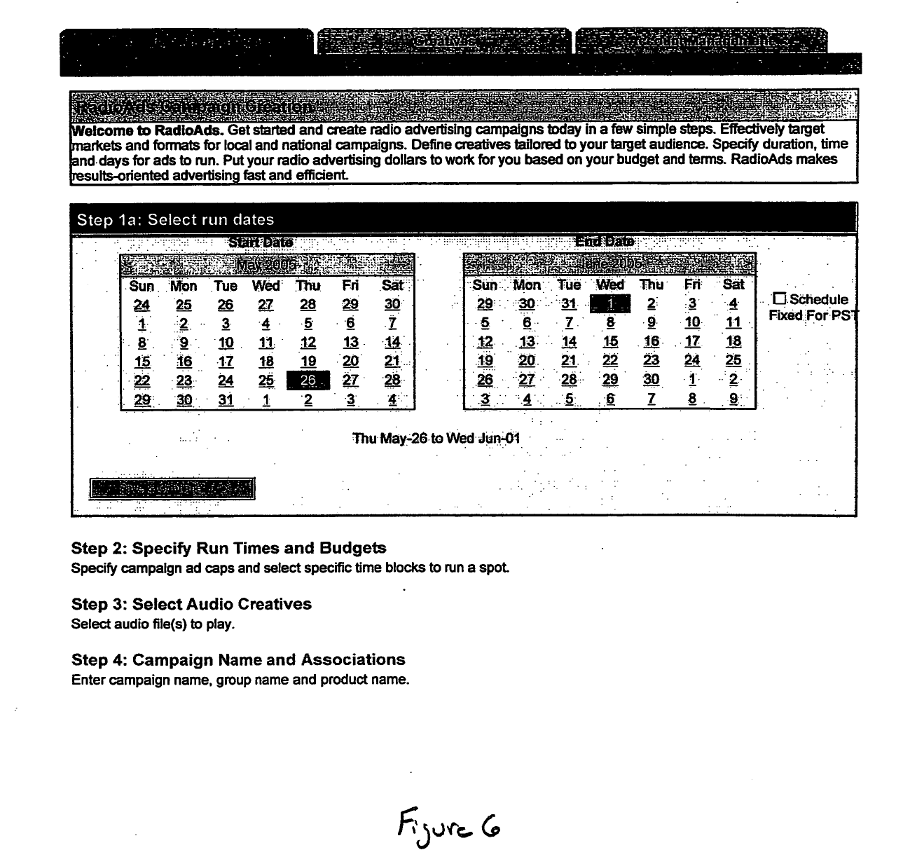

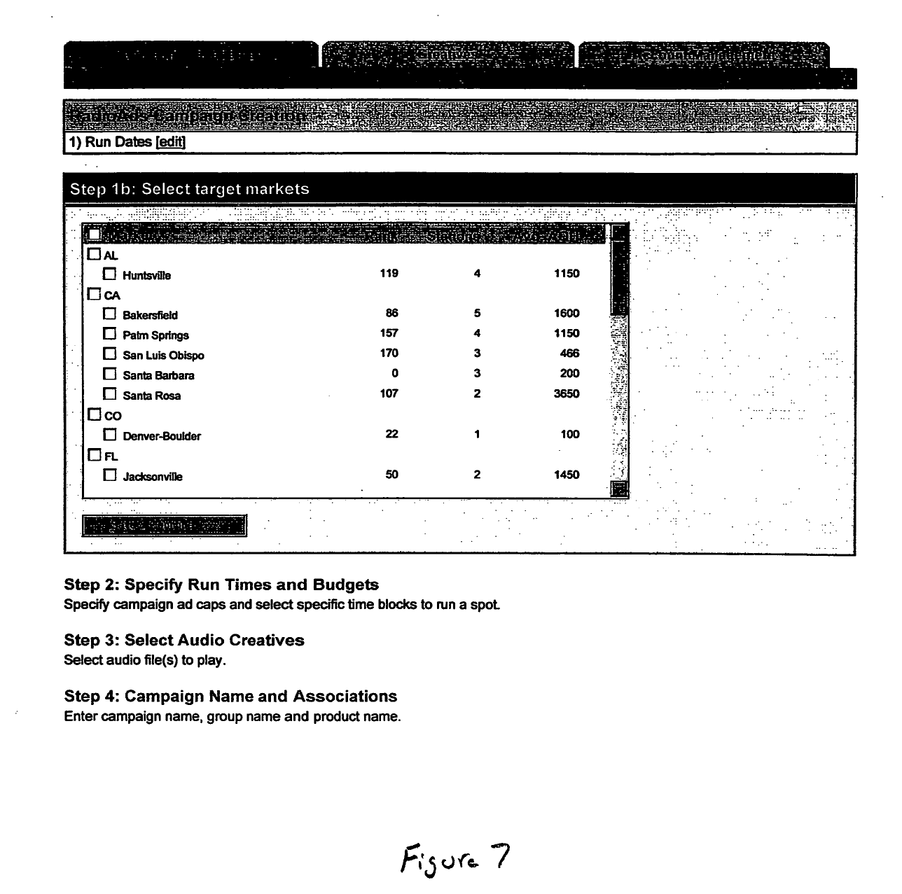

Referring now to FIG. 6, there is shown a window displayed to select the timing of the ad campaign. This window is activated by continuing from the window of FIG. 5. It is also necessary to select the dates to run the campaign. As may be seen, ‘Calendar View’ helps users select the dates from a start date to an end date. Once the dates are selected, the user presses ‘Save’ and ‘Continue’. Continuing in FIG. 6 activates the window of FIG. 7.

In FIG. 7, the target market or markets may be selected. For example, an entire market for the State of Alabama may be selected or just a regional area such as Huntsville may be selected. Within a given area, the station rank and the number of stations are provided. As may be seen, Colorado can break down into Denver and Boulder which has a rank of 22 with one station and 100 average AQH. Once the markets are selected, the user presses ‘Save’ and ‘Continue’.

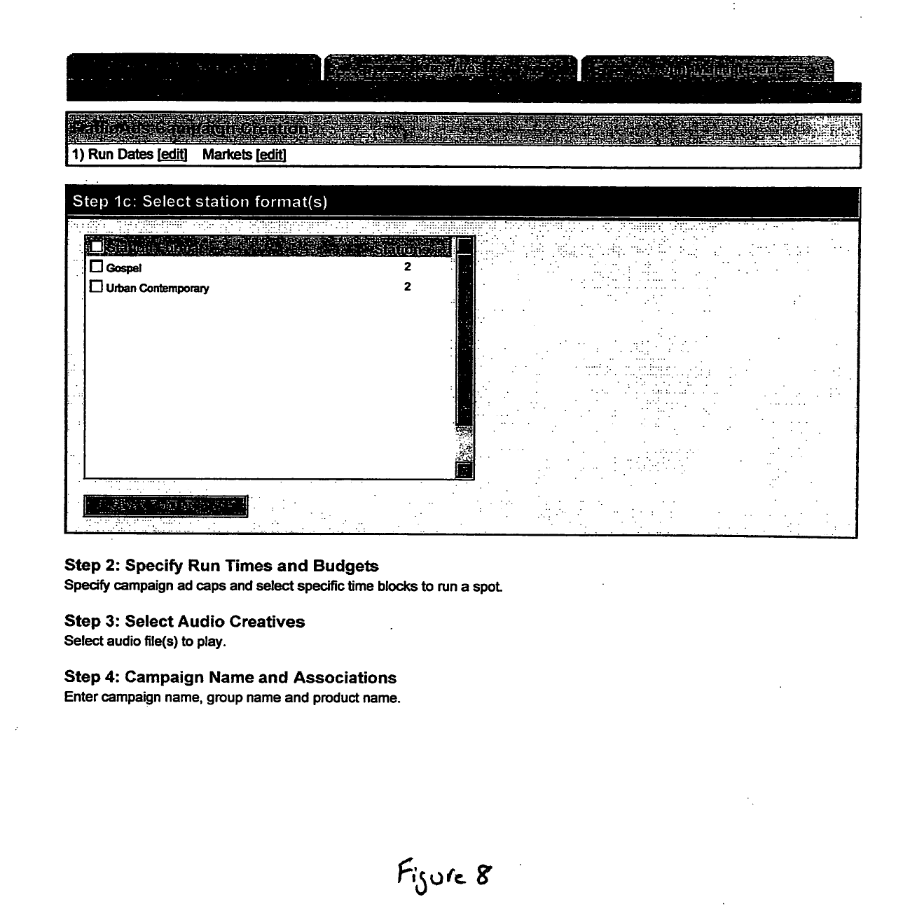

Based on the markets selected in FIG. 7, the window of FIG. 8 may be activated. In the window of FIG. 8, a user is directed to select the station format based on the markets selected in the window of FIG. 7, as only those available formats will appear in FIG. 8. As may be seen in the figure, Alabama, Huntsville was selected and it has two formats, a gospel format and an urban format, each with two stations of that format. Once the station format is selected, ‘Save’ and Continue' is pressed. Again a user may specify a format to run the ads on based on known characteristics. Based on the selection the window of FIG. 6 may be displayed.

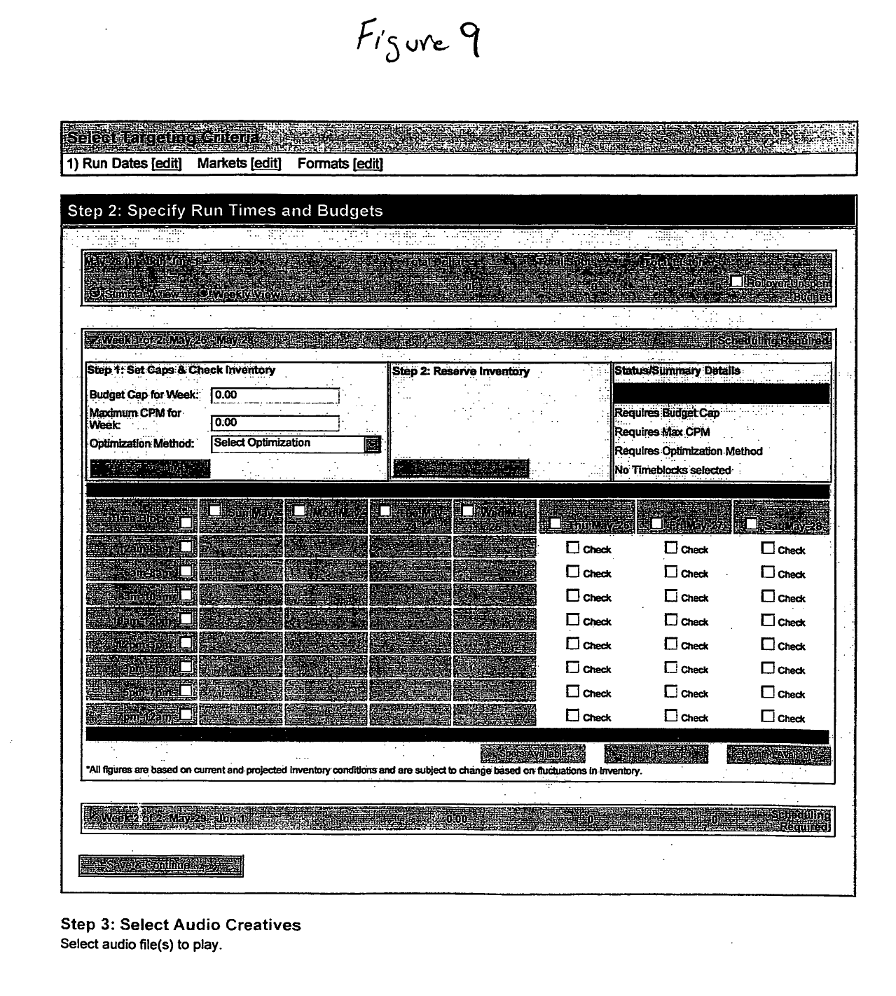

As may be seen in FIG. 9, run times and budgets may be specified. A summary view or a weekly view may be used. According to an aspect of the present invention, the first step would be to select the cap —such as the budget cap for the week, for example—and check the inventory—available ad spots meeting the defined criteria. In so doing, a budget cap for the week and a maximum CPM for the week may be selected. In addition, an optimization method may be selected. The optimization method may define the particulars of how spots are filled. For example, spots may be filled by maximizes the time allotted to the ads, by maximizing the number of people who may hear the ad, or some combination of the two, or an alternative optimization technique as would be evident to those possessing an ordinary skill in the arts. At which point, the inventory may be checked. In checking the inventory, a matching of the budget, the maximum CPM for the week and optimization method may be matched with the radio available ad times and the cost per each. This is the result of the search and these results may be displayed to the user for conformation or other review.

After completion of the set caps and check inventory, the ‘Check Inventory’ button may be depressed. The inventory on the selected radio station will be then indicated in the time blocks as spots available. Those boxes may then be checked and ‘Reserve Inventory’ may be depressed thereby demarking the inventory as spots reserved. If nothing came up available, all time blocks would be indicated as ‘Nothing Available’. Once the inventory that is available is selected, ‘Reserve Inventory’ may be depressed and the inventory is reserved according to this campaign.

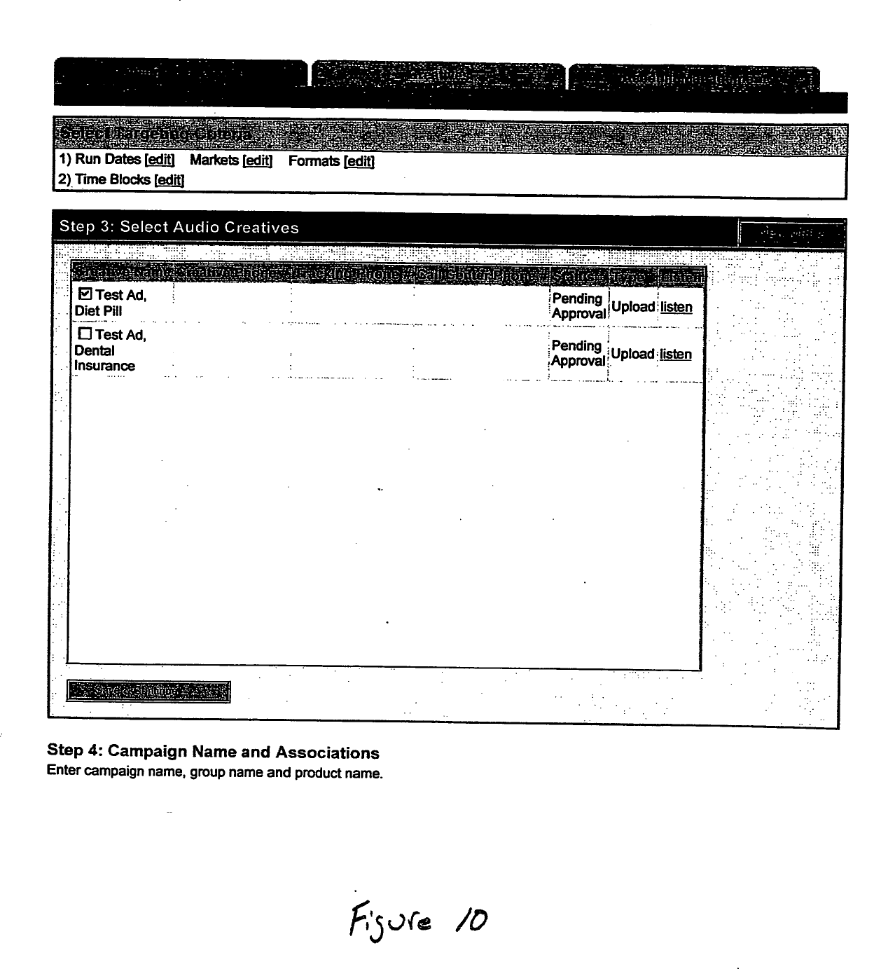

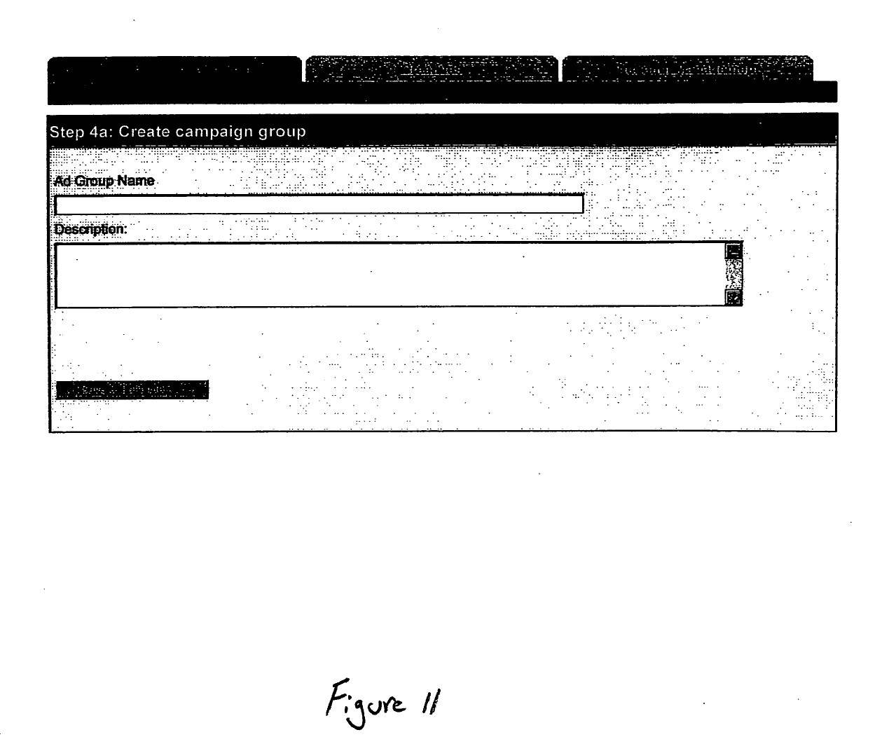

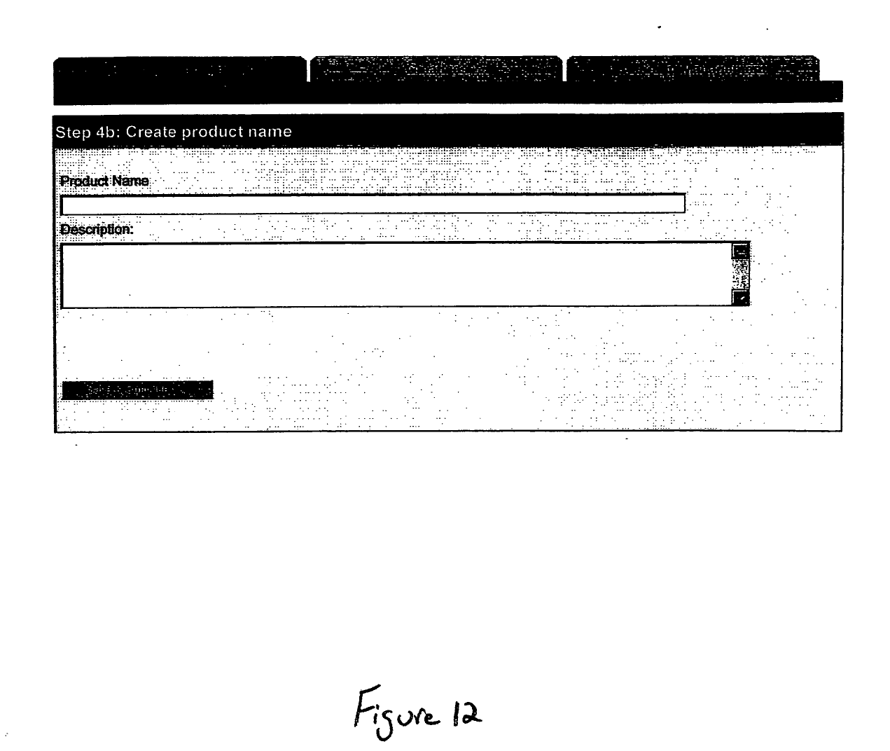

Upon completion of all weeks necessary to complete the campaign, the user may press ‘Save’ and ‘Continue’. Once the timeframes for the ads are selected, the campaign must be constructed to add in the creative. As may be seen in FIG. 10, select creatives may be used, created by and contained in the software or new media may be selected. New Media may be uploaded from a user database. The creative in the list of creatives may be listened to and then may be selected to be uploaded. Once the creative is selected, ‘Save’ and ‘Continue’ may be depressed. The list of ads may be grouped, as shown in FIG. 11, into a campaign and given an ad group name and a description so that it may be found conveniently at a later date. Also, these ads and campaigns can be grouped by the product name, as shown in FIG. 12, that they are advertising again for later ease of use.

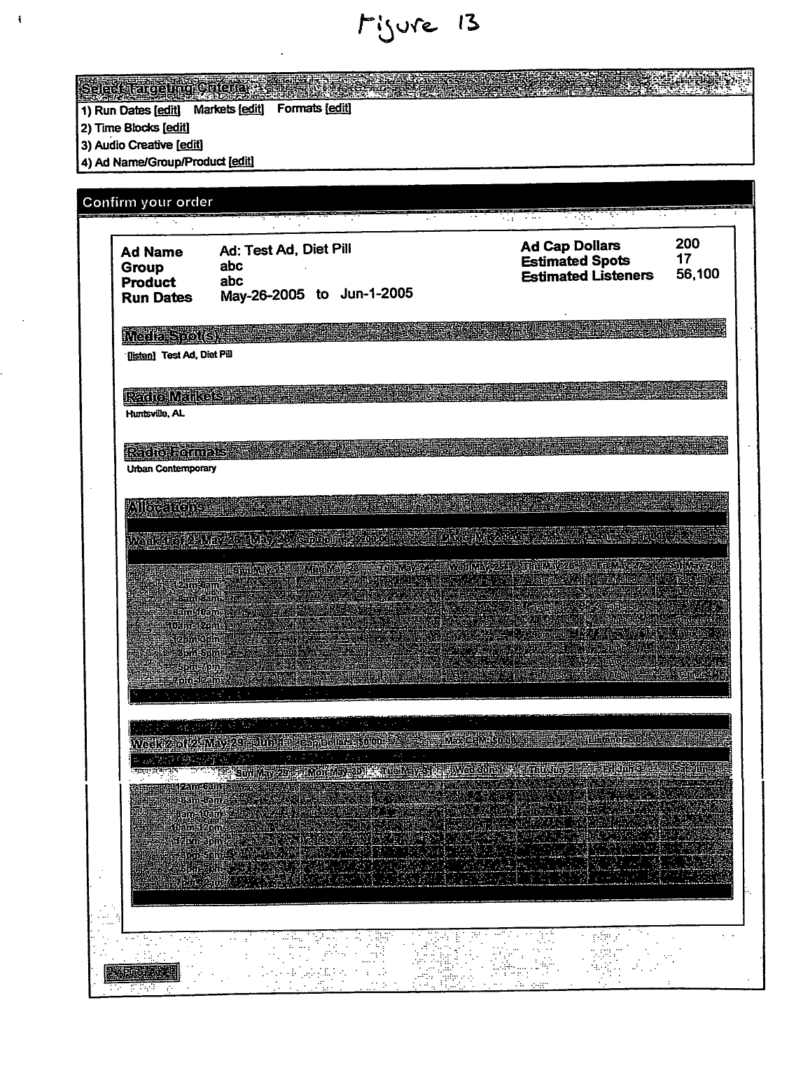

As shown in FIG. 13, upon completion of the ad campaign set-up, the select targeting set-up, there is a confirmation page that allows a user to view what they've selected when their ads are going to play, what the target is, how much money they are spending, and all the other information that they have put in thus far. Upon placing the ad at the bottom of the confirmation window, the ad will be created and we have gone through one full cycle of the campaign management. A new ad may be created and another campaign created just as we went through this one.

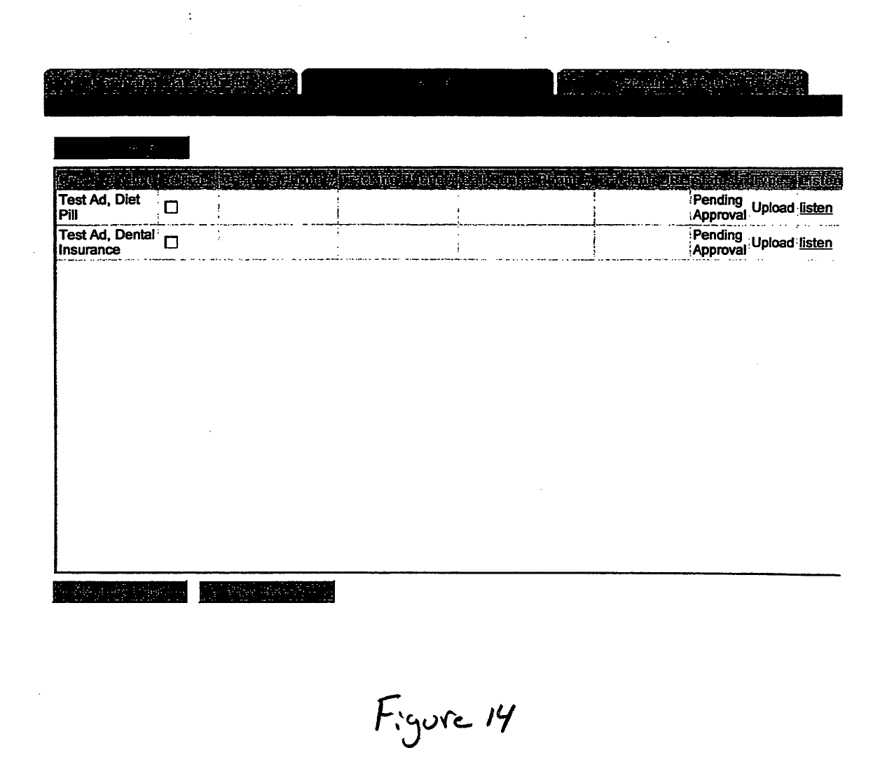

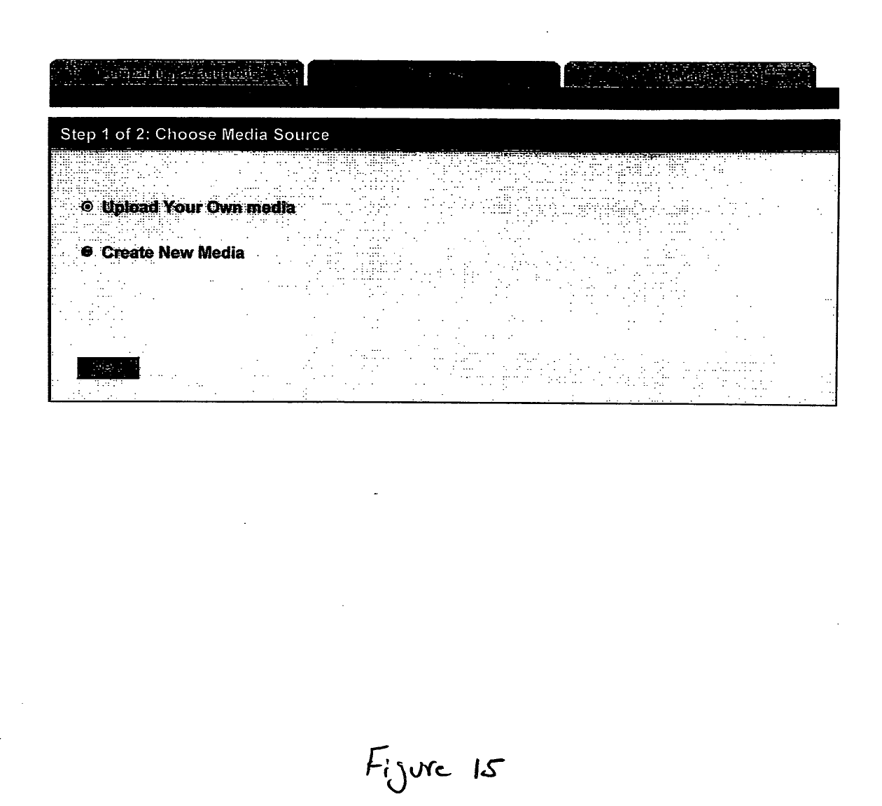

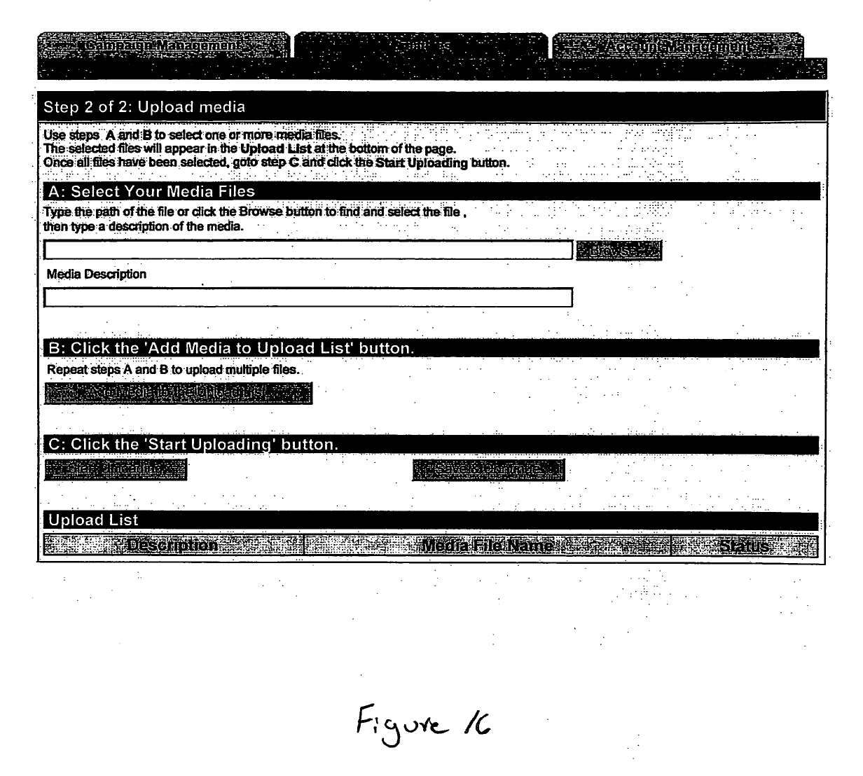

Under the Creative tab, shown in FIG. 4, there is a list of creatives that may be selected when going through a campaign. As shown in the window depicted in FIG. 14, new media may be uploaded, either as user's media or media may be created. In order to upload media, you just click on ‘Upload Media’ as shown in FIG. 15 and go to the Upload List, shown in FIG. 16, on a PC or other database that we have access to. Once the media is uploaded it will appear on a list so that it can be conveniently to campaigns.

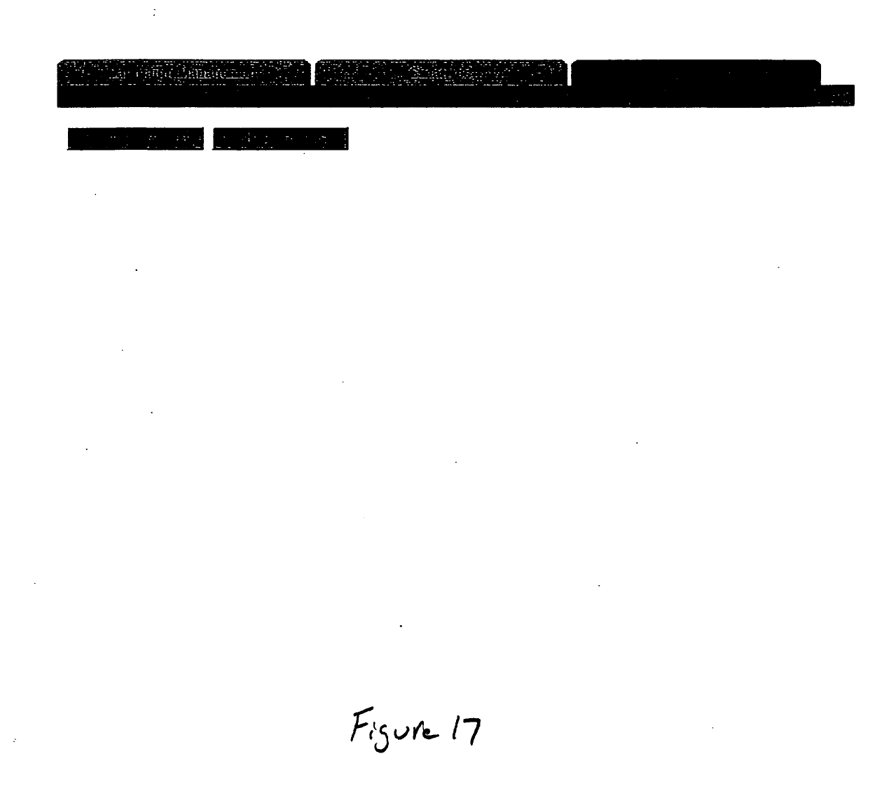

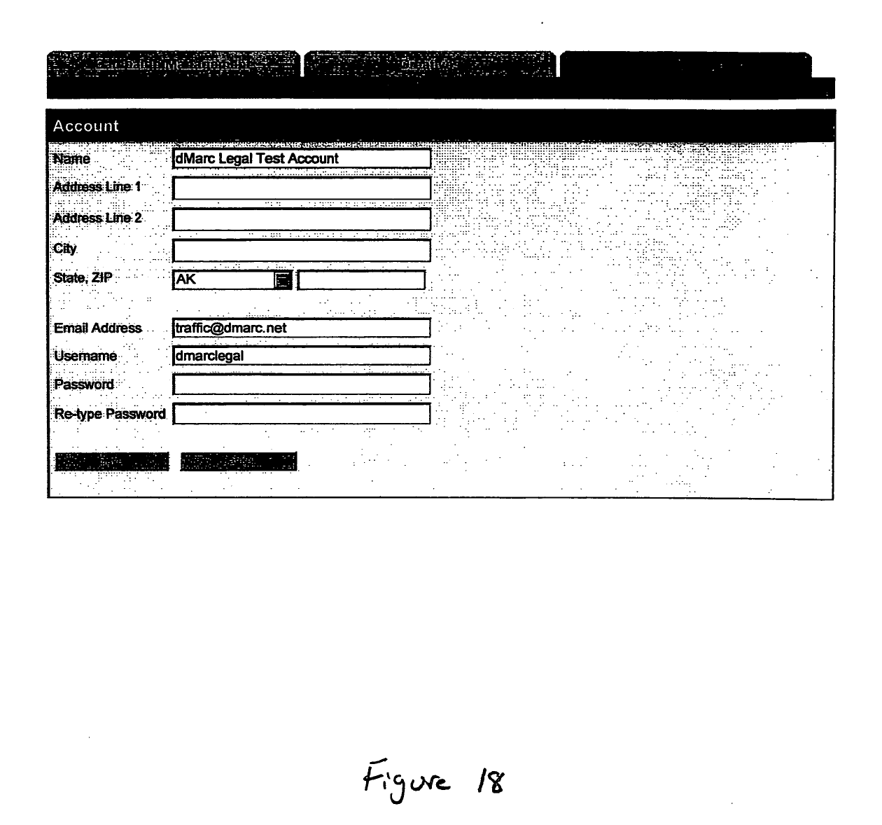

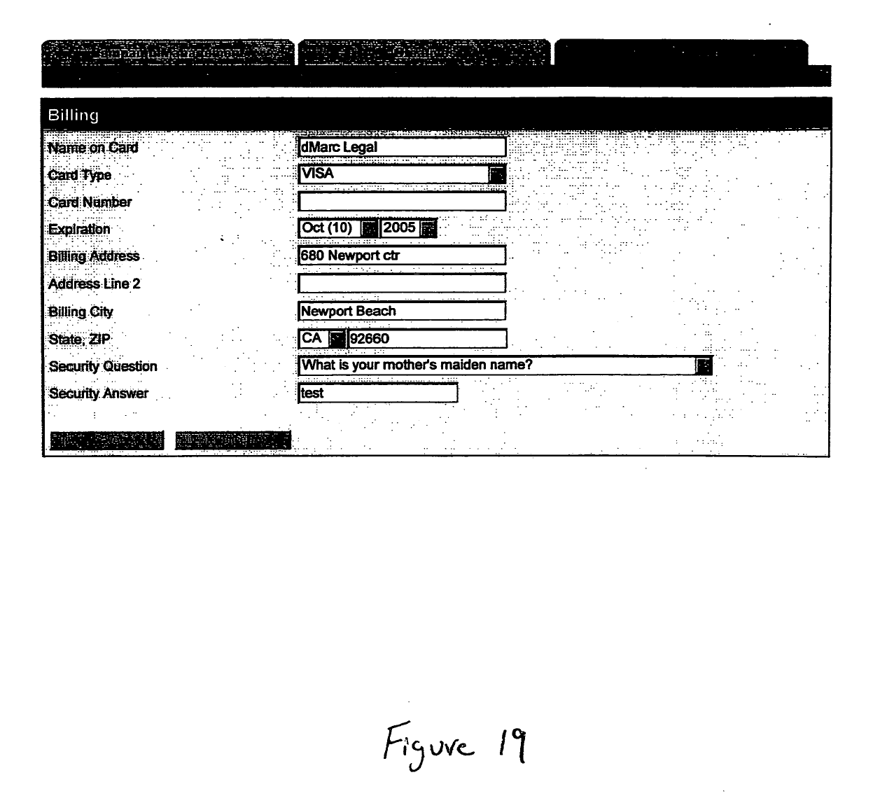

In the Account Management section, shown in FIG. 4, a user may look at the account settings and the billing settings, shown in FIG. 17. The account settings, shown in FIG. 18, may contain name, address, city, state, e-mail, username, password and other important information. And the billing information, shown in FIG. 19, may contain credit card information, expiration date, billing address, city, state and then also includes the standard security questions and answers.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A method for placing advertisements on select radio stations, said method comprising:
identifying the select radio stations based on at least one externally identifiable feature of each of said radio stations;
creating cost limits for the advertisements;
identifying possible criteria for the advertisements to play on at least one of said identified select radio stations based on said cost limits, wherein said identifying of the possible criteria is optimized; and
specifying at least one of the criteria for at least one of the advertisements to play on the at least one of said identified select radio stations.

2. The method of claim 1, further comprising reporting of said directly placed advertisements to review broadcast and airplay activity.

3. The method of claim 1, further comprising notifying of daily broadcast schedule including said directly placed advertisement.

4. The method of claim 1, wherein the time delay from placing the advertisement to playing the advertisements is less than approximately 72 hours.

5. The method of claim 1, wherein the time delay from placing the advertisement to playing the advertisements is less than approximately 48 hours.

6. The method of claim 1, wherein the time delay from placing the advertisement to playing the advertisements is less than approximately 24 hours.

7. The method of claim 1, further comprising creating said directly placed advertisement.

8. The method of claim 1, wherein said externally identifiable features consist of at least one of locale, broadcast type, genre of broadcast and number of listeners.

9. The method of claim 1, wherein the at least one of the advertisements is delivered to said identified select radio stations directly for the specified play.

10. The method of claim 1, the placed advertisements is a thirty second spot.

11. The method of claim 1, the placed advertisements is a sixty second spot.
